(19) United States
(12) Patent Application Publication
(10) Pub. No.: US 2010/0199670 A1
(43) Pub. Date: Aug. 12, 2010

(54) Power Generation Plant Having Inert Gas Deaerator and Associated Methods

(75) Inventors: Teri J. Robertson, Satellite Beach, FL (US); James C. Bellows, Maitland, FL (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Energy, Inc., Orlando, FL (US)

(21) Appl. No.: 12/366,716

(22) Filed: Feb. 6, 2009

(51) Int. Cl. F01K 19/00; F01K 21/06; B01D 19/00

(52) U.S. Cl. 60/657; 60/670; 60/646; 96/203

(57) ABSTRACT

A power generation plant includes a steam turbine and an electrical generator driven thereby. A condenser is downstream from the steam turbine. Moreover, the power generation plant includes a steam source and an inert gas source. A deaerator downstream from the condenser and is operable to perform deaeration using the inert gas source and is also selectively operable to perform deaeration using the steam source.

### FIELD OF THE INVENTION

The present invention relates to the field of power plants, and, more particularly, to deaerators for power plants and related methods.

### BACKGROUND OF THE INVENTION

A power generation plant typically includes a source of feedwater, a steam generator or boiler to heat the feedwater until the feedwater becomes steam, and a steam turbine to be rotated by a flow of steam from the steam generator. The steam turbine is coupled to an electrical generator by a rotatable driveshaft to thereby generate electricity as the steam turbine rotates.

After the flow of steam exits the steam turbine, it is directed into a condenser. The condenser cools the flow of steam until the flow of steam condenses back into liquid water, commonly called the condensate. The condensate may contain dissolved gasses. The dissolved gasses may be corrosive and corrode various metallic components of the power generation plant. Similarly, solid corrosion products may deposit on the surfaces of various components of the power generation plant, which may lead to localized overheating of some components and eventual component failure.

To reduce the amount of such dissolved gasses in the condensate, a dearator may be used. The deaerator removes the dissolved gasses from the condensate. The deaerated water is then fed back into the steam generator to be re-used to power the steam turbine.

IA condenser with a built in deaerator is described in U.S. Pat. No. 5,921,085 to Kawano. The condenser of Kawano includes a condenser tank to receive a flow of steam discharged from a steam turbine. A coolant tube bank carrying a flow of cold water runs through the condenser tank. The steam flows across the coolant tube bank and condenses. An inert gas injection valve in the condenser tank sparges the condensate with a flow of inert gas that flows from an inert gas supply. The sparging deaerates the condensate.

U.S. Pat. No. 4,896,500 to Pavel et al. discloses a deaeration system for a power generation plant including a deaerator and a storage tank coupled thereto. The deaerator includes a deaerator tank having spray nozzles inside. The spray nozzles spray condensate onto a series of deaeration trays. The deaeration has a steam inlet to receive steam from a steam source. The steam flows upward through the deaeration trays and deaerates the water as it flows over the trays. When the deaeration system is to be shut off, the water is drained from the deaeration system and nitrogen is pumped through the steam inlet into the deaeration tank from a nitrogen tank.

U.S. Pat. App. 2006/0010869 to Blangetti et al. discloses a deaerator for a power generation plant. A mixture of steam and non-condensable gasses are suctioned from a condenser and fed through a direct contact condensation device. Similarly, water from the condenser is pumped into the direct contact condensation device. The mixture of steam and non-condensable gasses flow through the direct contact condensation device in a countercurrent to water from the condenser to deaerate the water.

The aforementioned deaerators, however, may not remove as much dissolved gasses from the condensate as may be desired. In addition, such deaerators may remove the dissolved gasses from the condensate more slowly than may be desirable, such as after a maintenance outage.

### SUMMARY OF THE INVENTION

In view of the foregoing background, it is therefore an object of the present invention to provide a deaerator for a power generation plant.

This and other objects, features, and advantages in accordance with the present invention are provided by a power generation plant comprising a steam turbine and an electrical generator driven thereby. A condenser may be downstream from the steam turbine. In addition, there may be a steam source and an inert gas source. A deaerator may be downstream from the condenser and may be operable to perform deaeration using the inert gas source. The deaerator may also be selectively operable to perform deaeration using the steam source. The use of inert gas may help to remove dissolved gases, such as carbon dioxide and oxygen, from condensed water. This may help to extend the lifetime and service intervals of components of the power generation plant.

Furthermore, the use of inert gas is particularly advantageous when the power generation plant is being started after a maintenance outage and may quickly remove non-condensable gasses from the deaerator and dissolved gases from the condensate. After such a maintenance outage, the condensate may be saturated with dissolved gasses, such as carbon dioxide. Since the steam to run the steam turbine is generated from the condensate, it will likewise be saturated with undesired impurity gases at the thermodynamic conditions of the deaerator and will not be as effective as inert gas at deaerating the condensate in the deaerator.

The inert gas source may comprise a nitrogen gas source and the deaerator may comprise a deaerator tank. Nitrogen from the nitrogen gas source may be introduced into a bottom of the deaerator tank. There may be at least one spray nozzle in the deaerator tank and coupled to the condenser to receive a flow of water therefrom. Additionally, there may be at least one distributor trough in the deaerator tank below the at least one spray nozzle. Furthermore, there may be at least one deaeration tray in the deaerator tank below the at least one distributor trough. Also, the deaerator tank may have a vent opening.

Moreover, a controller may be coupled to at least one of the steam source and the inert gas source, the controller to selectively control a fluid flow from at least one of the steam source and the inert gas source. The controller may select whether to use inert gas only, or a combination of both inert gas and steam to the deaerator to optimize deaeration for different operating conditions of the power generation plant. In addition, the controller can control the vent opening and the amount of steam or inert gas that is vented to the atmosphere.

The power generation plant may also include a combustion turbine and an electrical generator driven thereby. The steam turbine may operate based upon waste heat from the combustion turbine. Such a power generation plant configuration is known as a combined-cycle power generation plant and is more efficient than a power generation plant running on a steam turbine alone or a power generation plant running on a combustion turbine alone.

Another aspect is directed to a deaerator for a power generation plant comprising a steam turbine and an electrical generator driven thereby, a condenser downstream from the steam turbine, and an inert gas source. The deaerator may comprise a deaerator tank and at least one spray nozzle positioned in the deaerator tank and coupled to a condenser to receive a flow of water therefrom. At least one deaeration tray is in the deaerator tank below the at least one spray nozzle. The deaerator tank is coupled to the inert gas source to receive a flow of inert gas therefrom, the flow of inert gas to deaerate the flow of water.

A method aspect is directed to a method of operating a power generation plant comprising driving an electrical generator with a steam turbine and condensing steam from the steam turbine into water with a condenser downstream of the steam turbine. The method includes operating a deaerator downstream from the condenser to deaerate the water using an inert gas source and to selectively deaerate the water using a steam source. The steam may come from the turbine exhaust, a higher pressure extraction port, or directly from the heat recovery steam generator, as appropriate to the operating conditions.

### BRIEF DESCRIPTION OF THE DRAWINGS

FIG. 1 is a schematic block diagram of a power generation plant in accordance with the present invention.

FIG. 2 is a schematic cross sectional view of the deaerator of the power generation plant of FIG. 1.

FIG. 3 is a schematic block diagram of an alternative embodiment of a power generation plant in accordance with the present invention.

FIG. 4 is a flowchart of a method of operating a power generation plant in accordance with the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternative embodiments.

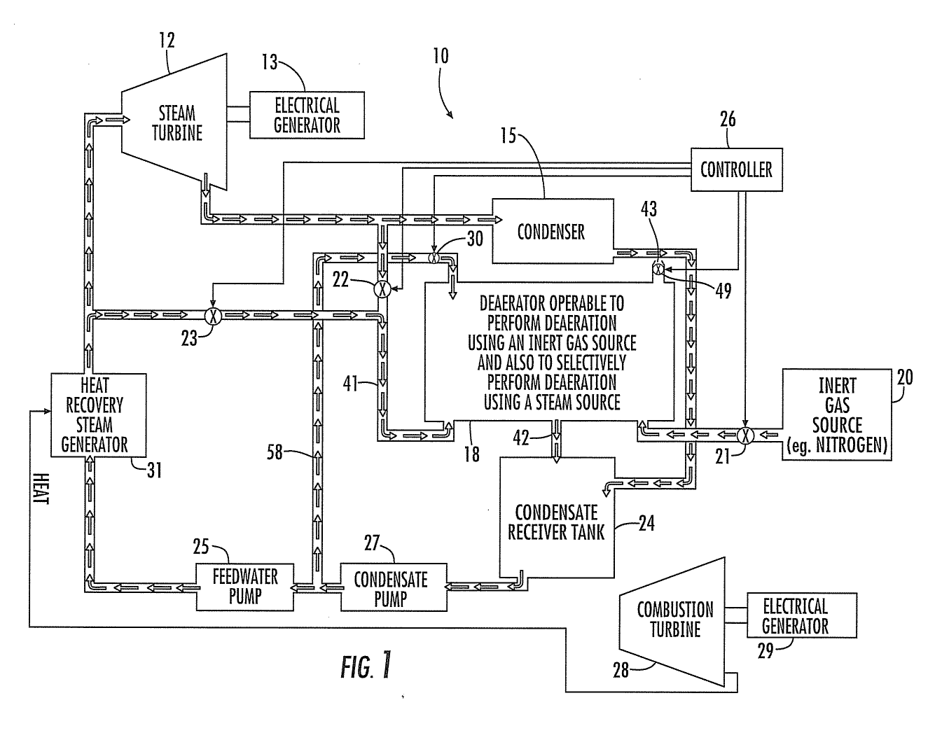

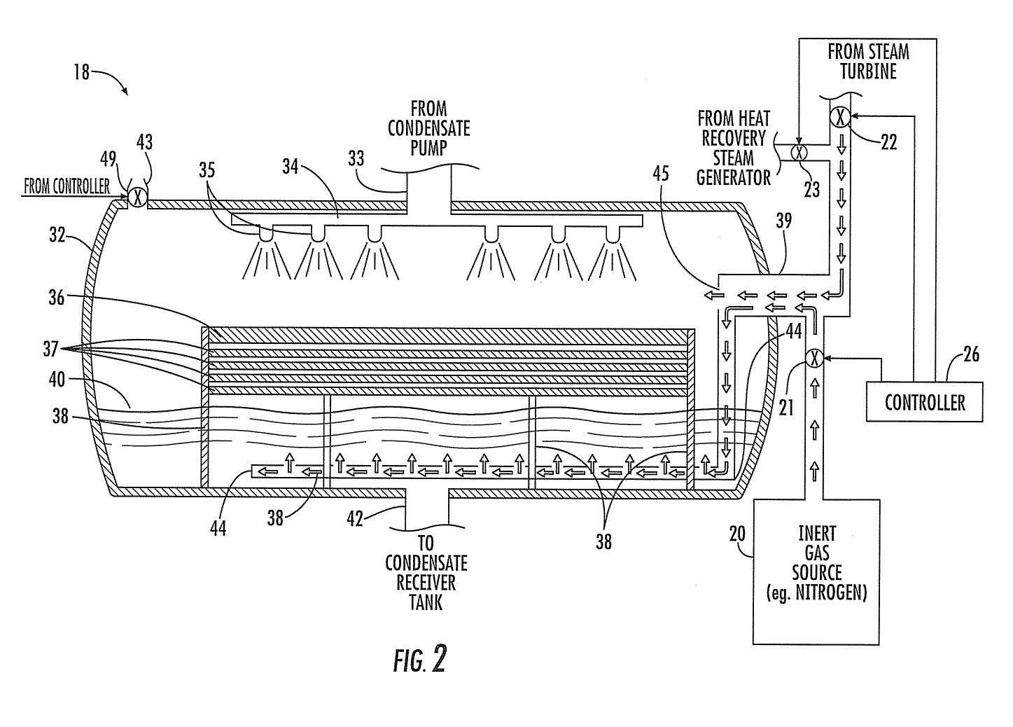

Referring initially to FIGS. 1-2, a power generation plant 10 is now described. The power generation plant 10 includes a steam turbine 12 and an electrical generator 13 driven thereby. A condenser 15 is coupled to the steam turbine 12 and receives a flow of steam therefrom. The condenser is illustratively an air-cooled heat exchanger in which the steam flows into tubes and is cooled by air on the outside. As the flow of steam enters the condenser 15 and flows through the cooling tubes, it is cooled thereby and condenses into liquid water (e.g. the condensate).

The condenser 15 is coupled to a condensate receiver tank 24 that receives the condensate. A condensate pump 27 pumps the condensate out of the condensate receiver tank 24 to a feedwater pump 25. A condensate pipe 58 between the condensate pump 27 and the feedwater pump 25 is coupled to the deaerator 18 to provide a flow of condensate thereto. An adjustable valve 30 regulates the flow of condensate into the deaerator 18.

The deaerator 18 comprises a deaerator tank 32 having a vent 43 defined therein. A valve 49 is coupled to the vent to control a fluid flow therethrough. The deaerator tank 32 also has a condensate inlet 33 defined therein to receive the condensate pumped thereto by the condensate pump 27 and through the valve 30. The deaerator tank 32 also has a deaeration fluid inlet 39 defined therein. The deaeration fluid inlet 39 is illustratively coupled to both an inert gas source 20 and a steam source 41, although of course, in some applications, the deaeration fluid inlet 39 may be coupled only to the inert gas source 20, or in other cases, only to the steam source. The inert gas source 20 may be a nitrogen storage tank, for example. Other inert gas sources 20, such as an argon gas tank, may also be used, as will be appreciated by those of skill in the art. The steam source 41 is illustratively a steam conduit carrying steam from a heat recovery steam generator 31 or an inlet or outlet of the steam turbine 12 to the deaeration fluid inlet 39, although other steam sources, such as a boiler may also be used. Those skilled in the art will recognize that the deaeration fluid inlet 39 may be within the deaerator tank 32 and that the steam and inert gas pipes penetrate the deaerator tank 32.

Valves 22, 23 are coupled between the ultimate steam source, the steam turbine 12 or the HRSG 31, and the steam source 41 and the deaeration fluid inlet 39 to selectively deliver the flow of steam thereto. Similarly, a valve 21 is coupled between the inert gas source 20 and the deaeration fluid inlet 39 to selectively deliver the flow of inert gas thereto. The valves 21, 22, 23 may be suitable valves as known to those of skill in the art, and may be mechanically operated, electrically operated, or pneumatically operated.

A distribution pipe 34 is positioned at the top of the deaerator tank 32 and coupled to the condensate inlet 33 to receive the condensate therefrom and to distribute the condensate to a plurality of spray nozzles 35. There may be a single spray nozzle 35 rather than a plurality of spray nozzles. The spray nozzles 35 may be conventional spray nozzles 35 as known to those of skill in the art.

A distributor trough 36 is in the deaerator tank 32 and under the spray nozzles 35. A plurality of deaeration trays 37 are under the distributor trough 36. Those of skill in the art will appreciate that there may be a plurality of distributor troughs 36, each of a suitable shape. Likewise, there may be a single deaeration tray 37 rather than a plurality thereof. Tray support rods 38 securely locate the distributor trough 36 and deaeration trays 37 in the deaerator tank 32.

The spray nozzles 35 spray the condensate onto the distributor trough 36. The distributor trough 36 may uniformly spill the condensate onto the uppermost deaeration tray 37. The condensate then cascades down through the series of deaeration trays 37 and may form a pool 40 at the bottom of the deaeration tank 32.

The deaerator trays 37 create a large surface area for the condensate to flow over, so that liquid-vapor equilibria may be achieved for the gasses dissolved in the condensate. During operation of the deaerator 18 and the power generation plant 10, inert gas and possibly steam flows into the deaeration tank 32 through the deaeration fluid inlet 39. This deaeration fluid flows upward through the deaeration trays 37 and sweeps away non-condensable gasses from the surface of the condensate water as it flows over the deaeration trays 37. In addition, the flow of deaeration fluid agitates the condensate and causes dissolved gases to separate therefrom. The deaerated water flows from an outlet 42 in the deaerator 18 to the condensate receiver tank 24 where it mixes with the non-deaerated condensate to form feedwater. Those skilled in the art will recognize that in conventional power plants, the deaerator 18 may drain to a deaerator storage tank, which may provide suction for the feedwater pump 25.

In the illustrated embodiment, there is an additional deaeration fluid manifold 44 located at the bottom of the deaerator 18. This deaeration fluid manifold 44 may bubble or sparge steam and/or inert gas through the pool 40 of condensate at the bottom of the deaeration tank 32 to deaerate the condensate. Likewise, the deaeration fluid inlet 39 may include an upper outlet 45 through which the deaeration fluid may flow above the deaeration trays 37 and through the condensate as it is sprayed by the spray nozzles 35.

The use of inert gas instead of, or in addition to steam for deaeration provides a variety of advantages. For example, when the power generation plant 10 is being started after a maintenance outage, the condensate and therefore the feedwater may be saturated with dissolved gasses, such as carbon dioxide. The steam to run the steam turbine 12 will be generated from the feedwater and may be similarly saturated. Since the steam and condensate will be similarly saturated with the dissolved gases, there will be a small concentration gradient for degassing if steam and not inert gas is used as the deaeration fluid. Consequently, it may take an undesirable period of time for the levels of carbon dioxide and other dissolved gases to fall to below a threshold level.

The use of an inert gas, for example nitrogen, as a deaeration fluid allows for quicker deaeration because there will be a much larger concentration gradient (as the inert gas may not include carbon dioxide or other undesirable gases). Since an excess amount of dissolved gases in the feedwater may lead to corrosion of components of the power generation plant 10, the ability to quickly remove such dissolved gases after a maintenance outage is particularly advantageous.

Furthermore, during normal operation of the power generation plant 10, if steam alone is used as the deaeration fluid, an equilibrium point will be reached between the dissolved gas concentrations in the steam and the condensate. The deaerator 18 may be unable to reduce the amount of dissolved gases in the condensate below this equilibrium level, as there will be no concentration gradient between the incoming steam and the condensate. The use of the inert gas in the deaerator 18 as the deaeration fluid allows the amount of dissolved gases in the condensate to be reduced below this equilibrium level, thereby reducing the corrosion done by those dissolved gases to the components of the power generation plant 10. In addition, when steam is used as the deaeration fluid, some of the steam may escape from the vent 43 in the deaerator tank 32. Such a loss of steam may be undesirable.

An optional controller 26 is illustratively coupled to each of the valves 21, 22, 23 to selectively regulate the flow of steam and/or inert gas to the deaeration fluid inlet 39. Likewise, the controller 26 is coupled to valve 30 to regulate the flow of condensate into the deaerator 18. The controller 26 is also coupled to valve 49 to regulate the flow is fluid through the vent 43.

The controller 26 may electrically operate the valves 21, 22, 23, 30, 49 or, alternatively, may pneumatically operate the valves. In addition, the valves 21, 22, 23, 30, 49 may be operated manually rather than by the controller. The controller 26 may select whether inert gas only, or a combination of steam and inert gas flows into the deaeration fluid inlet 39 to deaerate the condensate. In addition, the controller 26 may operate the valves 21, 22, 23 to provide differing amounts of steam and/or inert gas to the deaerator 18 to match an operating condition of the power generation plant 10. For example, as explained above, after a maintenance outage, it is particularly helpful for nitrogen to be used as a deaeration fluid during deaeration. Indeed, it may be desirable for only inert gas to be used as a deaeration fluid for a period of time after a maintenance outage.

The controller 26 may control valve 49 coupled to the vent 43 to maintain a positive pressure in the deaerator 18. The valve 49 limits the flow of steam or inert gas out of the vent 43, and thereby the total quantity used. When the condensate is very contaminated, the controller 26 may control the valve 49 to be open. When the condensate is close to the desired composition, the valve 49 may be nearly closed. Intermediate positions are of course possible, as appropriate. If neither steam nor inert gas is flowing to the deaerator, the valve 49 may be entirely closed.

There may be one or more sensors (not shown) in a component of the power generation plant 10, for example the heat recovery steam generator, and the controller 26 may selectively provide steam and/or inert gas to the deaerator 18 based upon readings of the sensors. For example, if the sensors sense that the concentration of carbon dioxide in the steam is higher than a threshold value, the controller 26 may increase the flow of inert gas to the deaerator 18. Likewise, if the sensors sense that the concentration of carbon dioxide in the steam is lower than a threshold value, the controller 26 may decrease the flow of inert gas to the deaerator 18 and may increase the flow of steam thereto.

Those of skill in the art will recognize that the type of deaerator 18 disclosed described in detail herein is a spray-tray deaerator. The spray-tray deaerator 18 is effective because it incorporates three deaerating mechanisms (e.g. spraying the condensate, spilling the condensate over a series of deaeration trays 37, and sparging a deaeration fluid through the pool 40 of condensate). It is to be understood, however, that other types of deaerators 18 may be utilized by the present invention, such as spray, tray, and spray-scrubber.

The power generation plant 10 illustratively includes an optional combustion turbine 28 and an electrical generator 29 coupled thereto. The combustion turbine 28 may be of a type known to those of skill in the art and may burn natural gas, oil, gassified coal, or other fuels. Waste heat from the combustion turbine 28 is fed to the heat recovery steam generator 31 coupled thereto. The heat recovery steam generator 31 generates steam by heating feedwater provided thereto by the feedwater pump 25 with the waste heat from the combustion turbine 38. Those of skill in the art will recognize that the heat recovery steam generator 31 may also have an internal or external heater to heat the feedwater in the heat recovery steam generator 31. The steam from the heat recovery steam generator 31 drives the steam turbine 12.

Those of skill in the art will understand that a boiler may be used to generate steam to run the steam turbine 12 instead of the heat recovery steam generator 31. Accordingly, the combustion turbine 28 is therefore optional.

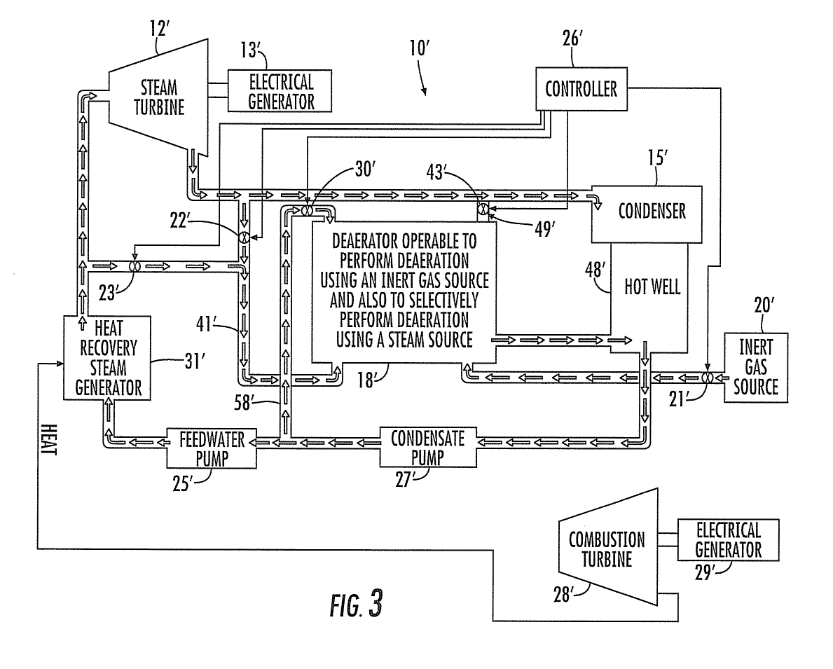

With reference to FIG. 3, an alternative embodiment of a power generation plant 10′ is now described. In this embodiment, the condenser 15′ is a water-cooled heat exchanger and comprises a condenser tank 15′ through which a series of coolant tubes run. A coolant, typically water from a cooling tower, is pumped through the coolant tubes. As the flow of steam enters the condenser 15′ and flows across the coolant tubes, it is cooled thereby and condenses into liquid water (e.g. the condensate). The condensate flows from the condenser 15′ into a hotwell 48′. A condensate pump 27′ pumps the condensate out of the hotwell 48′. Those other elements not specifically mentioned are indicated with prime notation and are similar to the elements described above with reference to FIGS. 1-2. Accordingly, those other elements require no further description herein.

With reference to FIGS. 1-2, a method of starting a power generation plant 10 is now described. If the condensate contains more undesirable dissolved gases than are desired, the condensate is sprayed into the deaerator 18. No steam is available because the power generation plant 10 has not been started, but inert gas may be used in the deaerator 18 to remove the undesired gases. When the undesirable gases are reduced to a desired concentration, the power plant 10 may then be started. This method protects the power plant 10 from an initial surge of undesirable dissolved gases while steam is first being generated.

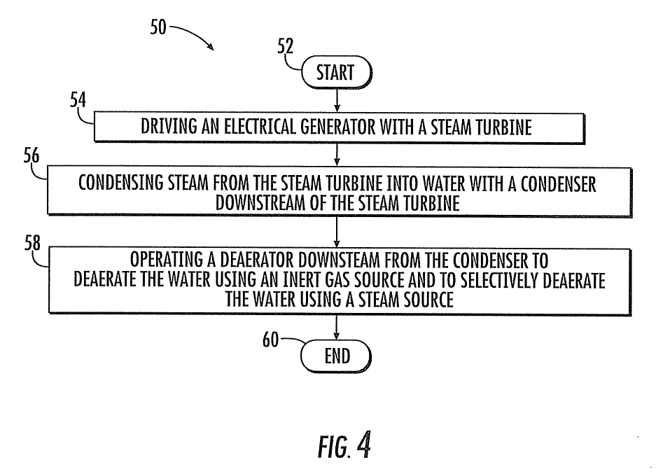

With reference to the flowchart 50 of FIG. 4, a method of operating a power generation plant 10 is now described. After the start (Block 52), at Block 54, an electrical generator 13 is driven by a steam turbine 12. At Block 56, steam from the steam turbine 12 is condensed into water by a condenser 15 downsteam of the steam turbine. At Block 58, a deaerator 18 is operated downstream from the condenser 15 to deaerate the water using an inert gas source 20 and to selectively deaerate the water using a steam source 41. Block 60 indicates the end of the method.

Although the deaerator 18 has been described with reference to its use in a power generation plant 10, those skilled in the art will recognize that the deaerator may also be used in other applications, such as a steam plant.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A power generation plant comprising:
a steam turbine and an electrical generator driven thereby;
a condenser downstream from said steam turbine;
a steam source;
an inert gas source; and
a deaerator downstream from said condenser and being operable to perform deaeration using said inert gas source and also being selectively operable to perform deaeration using said steam source.

2. The power generation plant of claim 1 wherein said inert gas source comprises a nitrogen gas source; wherein said deaerator comprises a deaerator tank; and wherein *nitrogen from the nitrogen gas source* is introduced into a bottom of said deaerator tank

3. The power generation plant of claim 1 wherein said deaerator comprises a deaerator tank; and further comprising at least one spray nozzle in said deaerator tank and coupled to the condenser to receive a flow of water therefrom.

4. The power generation plant of claim 3 further comprising at least one distributor trough in said deaerator tank below said at least one spray nozzle.

5. The power generation plant of claim 4 further comprising at least one deaeration tray in said deaerator tank below said at least one distributor trough.

6. The power generation plant of claim 1 further comprising a controller coupled to at least one of said steam source and said inert gas source, said controller to selectively control a fluid flow from at least one of said steam source and said inert gas source.

7. The power generation plant of claim 6 wherein said deaerator comprises a deaerator tank and a vent therein; and wherein the controller is also coupled to said vent to selectively control a fluid flow therethrough.

8. The power generation plant of claim 1 further comprising a combustion turbine and an electrical generator driven thereby; and wherein said steam turbine operates based upon waste heat from said combustion turbine.

9. The power generation plant of claim 1 further comprising a condensate receiver tank coupled to said condenser; wherein a first amount of water flows from said condenser to said deaerator; and wherein a second amount of water flows from said deaerator to said condensate receiver tank, the second amount being greater than the first amount.

10. A deaerator comprising:
a deaerator tank;
at least one spray nozzle positioned in said deaerator tank to be coupled to a condenser to receive a flow of water therefrom; and
at least one deaeration tray positioned in said deaerator tank below said at least one spray nozzle;
said deaerator tank to be coupled to an inert gas source to receive a flow of inert gas therefrom, the flow of inert gas to deaerate the flow of water.

11. The deaerator of claim 10 wherein said inert gas source comprises a nitrogen gas source; and wherein nitrogen from the nitrogen gas source is introduced into a bottom of said deaerator tank.

12. The deaerator of claim 10 further comprising at least one distributor trough in said deaerator tank above said at least one deaeration tray.

13. A method of operating a power generation plant comprising:
driving an electrical generator with a steam turbine;
condensing steam from the steam turbine into water with a condenser downstream of the steam turbine; and
operating a deaerator downstream from the condenser to deaerate the water using an inert gas source and to selectively deaerate the water using a steam source.

14. The method of claim 13 wherein the inert gas source comprises a nitrogen gas source.

15. The method of claim 13 further comprising selectively controlling a fluid flow from at least one of the steam source and the inert gas source using a controller coupled to at least one of the steam source and the inert gas source.

16. The method of claim 13 wherein the fluid flow is selectively controlled based upon at least one operating condition of the power generation plant.

17. The method of claim 13 wherein the deaerator comprises a deaerator tank and a vent therein; and further comprising selectively controlling a fluid flow from the vent using a controller coupled thereto.

18. The method of claim 13 wherein the deaerator comprises a deaerator tank; and wherein the deaerator further comprises at least one spray nozzle in the deaerator tank and coupled to the condenser to receive a flow of water therefrom.

19. The method of claim 18 wherein the deaerator further comprises at least one distributor trough in the deaerator tank below the at least one spray nozzle.

20. The method of claim 19 wherein the deaerator further comprises at least one deaeration tray in the deaerator tank below the at least one distributor trough.
